(19) United States
(12) Patent Application Publication
(10) Pub. No.: US 2014/0053649 A1
(43) Pub. Date: Feb. 27, 2014

(54) MONITORING UNIT AND METHOD FOR DETECTING STRUCTURAL DEFECTS WHICH CAN OCCUR IN AN AIRCRAFT NACELLE DURING USE

(71) Applicant: AIRCELLE, Gonfreville L'Orcher (FR)

(72) Inventor: Hakim MAALIOUNE, Orgeval (FR)

(73) Assignee: AIRCELLE, Gonfreville L'Orcher (FR)

(21) Appl. No.: 14/068,722

(22) Filed: Oct. 31, 2013

Related U.S. Application Data
(63) Continuation of application No. PCT/FR2012/050799, filed on Apr. 12, 2012.

(30) Foreign Application Priority Data
May 2, 2011 (FR) 11/53717

(51) Int. Cl. G01N 29/44; G01N 29/12

(52) U.S. Cl. CPC G01N 29/4445; G01N 29/12
USPC 73/583

(57) ABSTRACT

The present disclosure relates to a monitoring assembly for detecting structural detects. The monitoring assembly includes a composite sandwich structure with two distinct strata, a calculation unit and a plurality of sensors for generating signals representative of an amplitude or frequency of vibrations produced in a structure. Each sensor is formed by an electromechanical microsystem including a converter for converting mechanical energy into electrical energy. In particular, the calculation unit evaluates differences between a current transfer function resulting from the signals and a predetermined nominal transfer function, compares each of the differences with a respective detection threshold, and evaluates a size or a position of the structural defect in the structure.

### CROSS-REFERENCE TO RELATED APPLICATIONS

This application is a continuation of International Application No. PCT/FR2012/050799, filed on Apr. 12, 2012, which claims the benefit of FR 11/53717, filed on May 2, 2011. The disclosures of the above applications are incorporated herein by reference.

### FIELD

The present disclosure relates to a monitoring assembly and a method for detecting structural defects that may appear in an aircraft nacelle in service.

### BACKGROUND

The statements in this section merely provide background information related to the present disclosure and may not constitute prior art.

In the prior art, described in U.S. Pat. No. 6,006,163, a monitoring assembly carries out the non-destructive testing of certain components of an airplane engine. Such a monitoring assembly comprises several piezoelectric sensors connected to a calculation unit. The piezoelectric sensors can measure the amplitude of the vibrations only on the external surface of the component to be monitored. The piezoelectric sensors communicate their measurements to the calculation unit, which analyzes these measurements, so as to signal the possible appearance of a structural defect.

However, each piezoelectric sensor must be connected by electrically conducting cables, on the one hand, to a supply source, and on the other hand, to the calculation unit. The installation of such a supply source and of such connections is difficult and expensive to carry out. Furthermore, such connections exhibit significant risks of breakage because of the vibrations and shocks undergone by the component to be monitored. Such a monitoring assembly is therefore very unreliable, since, in the case of a breakage, a structural defect might not be detected.

### SUMMARY

The present disclosure provides a monitoring assembly, for detecting structural defects that may appear in an aircraft nacelle in service, comprising:

at least one composite material sandwich structure with at least two distinct strata, the structure being adapted for forming at least one part of the aircraft nacelle;

several sensors arranged so as to generate signals representative at least of an amplitude and/or of a frequency of vibrations produced in the structure when the aircraft nacelle is in service, each sensor being adapted for emitting said signals by electromagnetic waves, for example by radiofrequency, each sensor being formed by an electromechanical microsystem (MEMS) comprising means for converting mechanical energy, such as the energy of a shock or of vibrations, into electrical energy; and

at least one calculation unit adapted:
for evaluating the differences existing between a current transfer function resulting from said signals and a predetermined nominal transfer function;
for effecting a comparison between each of said differences and a respective detection threshold; and
on the basis of said comparison, for estimating or evaluating the size and/or the position of said structural defect in the structure.

Stated otherwise, a monitoring assembly in accordance with the present disclosure comprises energetically autonomous MEMS sensors able to communicate wirelessly with the calculation unit(s), which is(are) able to analyze the measurements transmitted by each sensor.

In the present disclosure, the adjective “conducting” and the verbs “conduct”, “connect” and “hook up” pertain to the conduction of electricity, generally carried out by means of a solid conductor.

An energetically autonomous sensor is a sensor which can supply itself with electrical energy. The MEMS sensors fitted to an assembly in accordance with the present disclosure convert the mechanical energy of shocks or vibrations into electrical energy. Indeed, each of these MEMS sensors comprises an electromechanical microsystem which forms a sort of micro-alternator adapted for generating the electrical energy which the other elements of the MEMS sensor need in order to operate. Stated otherwise, each MEMS sensor produces by itself the electrical energy which is required for its operation.

Thus, the energy supply of such a MEMS sensor has zero environmental impact, since this MEMS sensor produces electrical energy on the basis of the shocks or vibrations undergone. Moreover, such MEMS sensors do away with having to wire electrical cables which were previously required for the piezoelectric sensors used in the prior art.

As the MEMS sensors are arranged so as to generate signals representative at least of an amplitude and/or of a frequency of vibrations produced inside the sandwich structure, the MEMS sensors make it possible to monitor the sandwich structure in its thickness, this not being possible in a prior art monitoring assembly where the sensors are glued or affixed to the external surface of the structure of a member.

Moreover, this arrangement of the sensors makes it possible to eliminate the problems of defective gluing and false information which might stem therefrom. Indeed, in a prior art monitoring assembly where the sensors are glued onto the external surface of the structure of a member, it is sometimes difficult to discriminate the signals emitted by a sensor detecting defective gluing to the structure from signals emitted by a sensor detecting a defect that has appeared in the structure.

Thus, such a monitoring assembly can be installed rapidly on the structure or nacelle to be monitored and it makes it possible to detect the possible appearance of a structural defect, inside the structure of a nacelle. Moreover, such a monitoring assembly operates reliably and has a high duration of service, since the sensors are robust and wireless.

In the present disclosure, the verbs “link”, “transmit” and their derivatives pertain to the transmission of signals by electromagnetic waves, without any conducting wire and by means of a direct or indirect linkup, that is to say by way of no, of one or of several component(s).

According to one form, a detection threshold is applied to the modulus of the current transfer function measured at a resonant frequency.

Thus, such a detection threshold in terms of amplitude or modulus makes it possible to determine the size of a structural defect.

According to another form, a detection threshold is applied to the number and/or to the value(s) of (the) resonant frequency (frequencies) of the current transfer function with respect to the nominal transfer function.

Thus, such a detection threshold in terms of frequency makes it possible to determine the position of a structural defect in the structure, in particular by utilizing the signals generated by several neighboring sensors forming a sort of network.

In still another form, each respective detection threshold is fixed in an absolute manner, preferably on the basis of the nominal transfer function.

Thus, such an absolute detection threshold makes it possible to determine the presence of a structural defect on the basis of the signals transmitted by a single sensor, after having if appropriate carried out correlations with the neighboring sensors so as to remove white noise and/or false information.

According to another form, each respective detection threshold is fixed in a relative manner, the calculation unit comparing a current transfer function resulting from the signals of a sensor with at least one current transfer function resulting from the signals of at least one distinct sensor.

Thus, such a relative detection threshold makes it possible to cross-check the measurements performed by several sensors, therefore to detect a structural defect of relatively small size.

According to one form, the monitoring assembly comprises several calculation units, each calculation unit being incorporated into a respective sensor.

Thus, such calculation units make it possible to transform into standardized signals (displacement, vibration and shocks etc.) the stresses which are generated essentially in displacement. Filterings can furthermore be carried out beforehand in order to extract the signal actually corresponding to a structural defect and to disregard the recurrent stresses related to the nominal vibration profile of the aircraft nacelle.

According to another form, a monitoring assembly according to the present disclosure comprises a calculation unit arranged remotely from the sensors and adapted for receiving said signals of each sensor.

Thus, such a calculation unit makes it possible to recover the standardized signals through radiofrequency links, thereby making it possible to correlate the various data, to authenticate the structural defect and to deduce its location or position therefrom. A summary of this information can then be effected and then transmitted to a diagnosis and ground maintenance tool or to a maintenance unit onboard the aircraft.

In another form of the present disclosure, a monitoring assembly furthermore comprises transmission facilities each adapted for receiving said signals of a respective sensor and for transmitting them to a respective calculation unit, the transmission facilities being formed by radiofrequency-based identification components onboard the aircraft.

Thus, such transmission facilities enable the transmission to a unit for calculating the signals emitted by the sensors; such transmission facilities are already set up on the aircraft, thereby limiting the costs of installing a monitoring assembly in accordance with the present disclosure. In this mode also, summarized information can be transmitted to a maintenance unit onboard the aircraft.

According to one form, each sensor emits said signals with an intensity greater than the attenuation effected by the structure.

Thus, such sensors ensure full transmission of the signals to the calculation unit.

According to another form, each sensor is of passive type and composed of silicon, each sensor preferably comprising mechanical counting means.

Thus, such a sensor is particularly compact and inexpensive.

In still another form, each sensor is integrated or embedded in the structure.

Stated otherwise, each sensor is integrated directly into the sandwich structure. For example, each sensor can be integrated or embedded in the matrix (generally a resin) of the composite material of which the sandwich structure is composed.

As the MEMS sensors are arranged so as to generate signals representative at least of an amplitude and/or of a frequency of vibrations produced inside the sandwich structure, the MEMS sensors make it possible to monitor the sandwich structure in its thickness, this not being possible in a prior art monitoring assembly where the sensors are glued or affixed to the external surface of the structure of a member.

Moreover, this arrangement of the sensors makes it possible to resolve the problems of defective gluing and the false information which might stem therefrom. Indeed, in a prior art monitoring assembly where the sensors are glued to the external surface of the structure of a member, it is sometimes difficult to discriminate the signals emitted by a sensor detecting defective gluing to the structure from signals emitted by a sensor detecting a defect that has appeared in the structure.

Thus, such sensors can be fastened in an easy and enduring manner to the structure.

In one form, the sensors are distributed at several points of the structure, so as to monitor the major part of the structure.

Thus, the distribution of the sensors makes it possible to cover the whole of the structure to be monitored.

According to another form, several sensors are arranged so as to measure vibrations produced between two distinct strata when the aircraft nacelle is in service.

Thus, sensors positioned at the interface between two strata of the structure make it possible to detect a possible detachment between these two strata.

According to one aspect of the present disclosure, the density of sensors is greater in the regions of the structure which are intended to undergo the most mechanical stresses. Thus, such regions are monitored in a securer manner.

According to another aspect of the present disclosure, each MEMS sensor is equipped with an electrical micro-accumulator for storing a part of the electrical energy produced by this MEMS sensor. Thus, the autonomy of such MEMS sensors is increased.

Moreover, the subject of the present disclosure is a monitoring method, for detecting structural defects that may appear in an aircraft nacelle in service, at least one part of the aircraft nacelle being formed by a composite material sandwich structure with at least two distinct strata, the monitoring method being characterized in that it comprises steps of:
actuating several sensors arranged so as to generate signals representative at least of an amplitude and/or of a frequency of vibrations produced in the structure when the aircraft nacelle is in service;
emitting, by means of each sensor, said signals by electromagnetic waves, for example by radiofrequency, each sensor being formed by an electromechanical microsystem (MEMS) comprising means for converting mechanical energy, such as the energy of a shock or of vibrations, into electrical energy;
evaluating, by means of at least one calculation unit, the differences existing between a current transfer function resulting from said signals and a predetermined nominal transfer function;
effecting, by means of the or of each calculation unit, a comparison between each of said differences and a respective detection threshold; and
on the basis of said comparison, estimating or evaluating the size and/or the position of said structural defect in the structure.

Thus, such a method makes it possible to detect the possible appearance of a structural defect, in a reliable manner.

According to a method in accordance with the present disclosure, a calculation unit predetermines a nominal transfer function. For this purpose, this calculation unit selects inlet parameters, in particular physical parameters, and then formulates a standardized representation or mathematical model, the transfer function, which is adapted to the nacelle to be monitored. The calculation unit thereafter compares this mathematical representation with thresholds defined in accordance with this same standard, thereby making it possible to detect the appearance of structural defects.

According to one form, a monitoring method furthermore comprises a step consisting in predetermining, at the level of each sensor, a nominal transfer function in the initial state of the structure before the aircraft nacelle is put into service.

Thus, the monitoring method records a “signature” of the healthy structure, that is to say before the appearance of a structural defect.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic view in perspective of a part of an aircraft nacelle associated with a monitoring assembly in accordance with the present disclosure;

FIG. 2 is a schematic view in perspective of components of the monitoring assembly of FIG. 1;

FIG. 3 is a sectional view of a structure according to the mediator plane III in FIG. 1;

FIG. 4 is a view similar to FIG. 3 and illustrating a structural defect in the aircraft nacelle of FIG. 1;

FIG. 5 is a chart illustrating an initial step of a monitoring method in accordance with the present disclosure and effecting a signal emitted by the monitoring assembly before the aircraft nacelle of FIG. 1 is put into service;

FIG. 6 is a chart similar to FIG. 5 illustrating a subsequent step of the monitoring method in accordance with the present disclosure and effecting a signal emitted by the monitoring assembly after the aircraft nacelle is put into service and after the appearance of the structural defect illustrated in FIG. 4; and

FIG. 7 is a chart similar to FIG. 6 illustrating another subsequent step of the monitoring method in accordance with the present disclosure and effecting another signal emitted by the monitoring assembly after the aircraft nacelle is put into service and after the appearance of the structural defect illustrated in FIG. 4.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

FIG. 1 illustrates an aircraft nacelle 1 which forms a tubular housing for a turbojet (not represented). The function of the aircraft nacelle 1 is in particular to channel the air streams generated by the turbojet. The nacelle 1 is situated globally under a wing 2 of the aircraft. A mast 3 ties the nacelle 1 to the wing 2.

The nacelle 1 comprises an upstream section forming an air inlet 4, a middle section 5 surrounding a fan (not represented), and a downstream section 6 surrounding the turbojet and sheltering a thrust reversal system (not represented). The function of the air inlet 4 is in particular to direct the air toward the turbojet so as to supply the fan and internal compressors of the turbojet.

At least one part of the nacelle 1 is formed by a structure 10 made as a composite material sandwich with several distinct strata, two of which bear the references 10.1 and 10.2 in FIG. 3. In the example of the figures, the air inlet 4, the middle section 5 and the downstream section 6 each comprise a part of the structure 10. In the present patent application, the term “structure” globally designates one or more component(s) arranged so as to confer mechanical strength on the aircraft nacelle.

To detect structural defects that may appear in the nacelle 1 in service, the structure 10 is equipped with a part of a monitoring assembly 11, which operates by non-destructive testing and comprises in particular two belts of sensors 12.

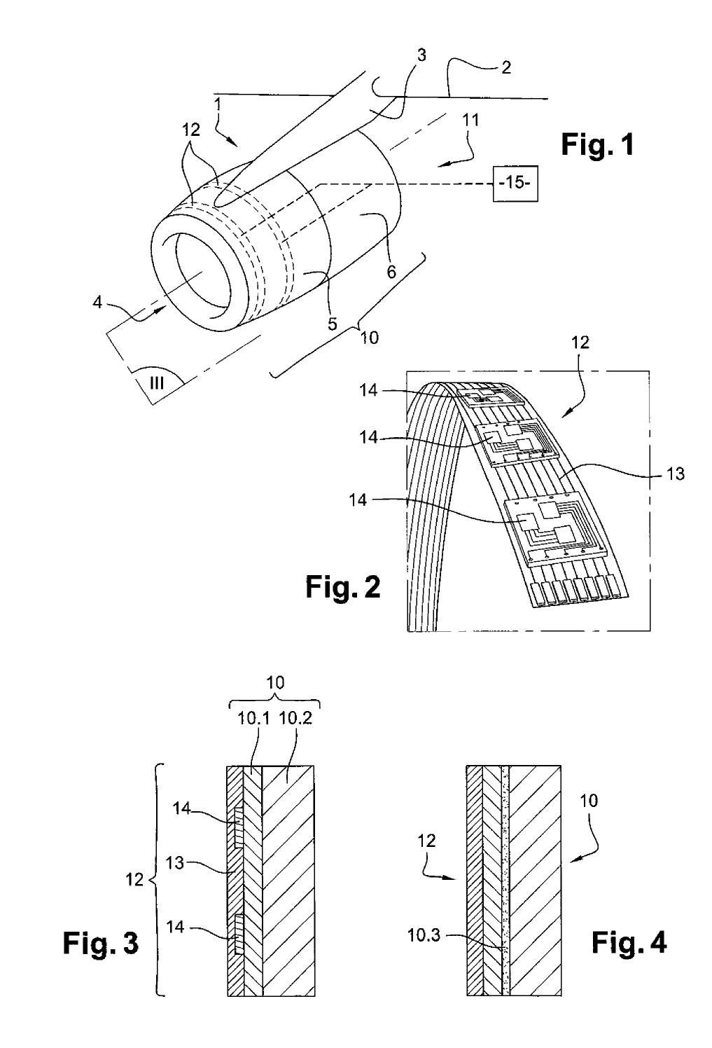

As shown by FIG. 2, each belt of sensors 12 is represented dashed in FIG. 1, since it is integrated into the structure 10 without appearing on the external surface of the nacelle 1. Each belt of sensors 12 comprises a tape 13 and several sensors 14. The sensors 14 are distributed at several points of the structure 10, so as to monitor the major part of the structure 10.

Each sensor 14 is formed by an electromechanical microsystem (usually designated by the English acronym MEMS) comprising means for converting mechanical energy, such as the energy of a shock or of vibrations undergone by the nacelle 1 in service, into electrical energy. Each sensor 14 is of passive type and preferably comprises mechanical counting means. For example, each sensor 14 can be formed by a ChronoMEMS® sensor produced by the company SilMach.

As shown by FIG. 3, the sensors 14 are glued to an external face of the stratum 10.1 of the structure 10, and then overlaid by another stratum. The sensors 14 are thus integrated inside the structure 10. Alternatively, these sensors can be directly integrated or embedded in a stratum, for example in the matrix (resin) of a composite material of which all or part of the structure 10 is composed. The sensors 14 are arranged so as to generate signals representative at least of an amplitude and/or of a frequency of vibrations produced in the structure 10 when the nacelle 1 is in service.

The distribution and the density of the sensors 14 depend on the type of structural defect to be detected by priority, since each structural defect generates an energy which is specific to it. For example, sensors 14 can be placed near the regions that are most subjected to mechanical stresses, or the density of sensors can be increased around these regions.

Each sensor 14 is adapted for emitting these representative signals by electromagnetic waves, for example by radiofrequency.

In practice, a sensor 14 comprises, on the one hand, a measurement facility of MEMS type, not represented, for generating these representative signals and, on the other hand, an emitter facility of MEMS type, not represented, for emitting these representative signals generated by the emission facility.

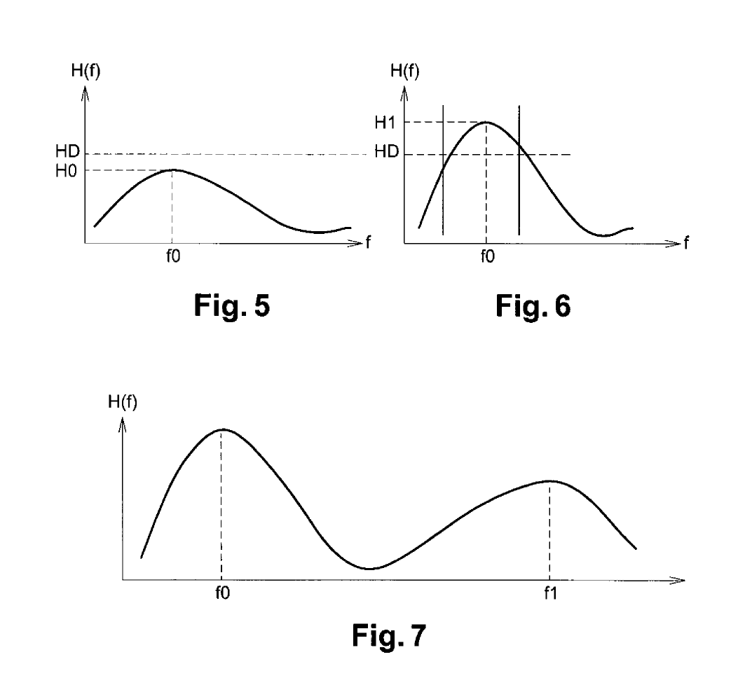

FIG. 5 illustrates signals representative of the vibrations produced at a given point of the structure 10, situated near the interface between the strata 10.1 and 10.2. These signals are generated by a sensor 14 referred to as proximal since it is situated near this point. FIG. 5 is a chart showing the variation of a modulus H(f) or amplitude of a transfer function as a function of the frequency f of the vibrations.

The curve illustrated in FIG. 5 represents a nominal transfer function, that is to say which is predetermined before the nacelle 1 is put into service, when the structure 10 is devoid of defects. The transfer function or frequency spectrum of these signals exhibits a resonant frequency f0 with an amplitude H0.

As shown by FIG. 1, the monitoring assembly 11 furthermore comprises a calculation unit 15, the function of which is in particular to analyze these representative signals, especially their spectra, for detecting the appearance of a structural defect in the nacelle 1.

The calculation unit 15 is arranged remotely from the sensors 14 and it is adapted for receiving these signals of each sensor 14. For this arrangement, each sensor 14 emits its signals with an intensity greater than the attenuation effected by the structure 10.

FIG. 4 illustrates a structural defect 10.3 that has appeared between the strata 10.1 and 10.2. The structural defect 10.3 corresponds here to a local detachment of the strata 10.1 and 10.2. Several sensors 14 are arranged so as to measure vibrations produced between the strata 10.1 and 10.2 when the nacelle 1 is in service.

After the appearance of the defect 10.3, FIG. 6 illustrates signals representative of the vibrations produced at the aforementioned given point. These signals are generated by the proximal sensor 14. The current transfer function arising from these signals still exhibits the resonant frequency f0 but with an amplitude H1 which is greater than the amplitude H0.

In the present disclosure, the term “current” qualifies a variable which is measured at a given instant in the course of service of the nacelle 1. This term “current” therefore corresponds to the adjective “instantaneous”.

After the appearance of a structural defect 10.3, when the structure 10 is naturally excited at an amplitude H0 and when the amplitude H1 of the signal at the resonant frequency f0 passes to the multiple of the gain times the amplitude H0, the presence of a structural defect 10.3 is detected at a given point, thereby giving the position of this structural defect 10.3.

The calculation unit 15 is adapted for evaluating the differences existing between the current transfer function (FIG. 6) resulting from the current signals and a predetermined nominal transfer function (FIG. 5). In the example of FIGS. 5 and 6, such a difference corresponds to the discrepancy between the amplitudes H1 and H0.

Moreover, the calculation unit 15 is adapted for effecting a comparison between each of said differences and a respective detection threshold. In the example of FIGS. 5 and 6, only a detection threshold HD is applied, in this instance to the modulus of the current transfer function (FIG. 6) measured at a resonant frequency f0.

The detection threshold HD is fixed beforehand at a value greater than the amplitude H0, for example at 120% of H0. Stated otherwise, the detection threshold HD is fixed in an absolute manner on the basis of the nominal transfer function (FIG. 5). The comparison effected by the calculation unit 15 establishes that the amplitude H1 is greater than the detection threshold HD.

On the basis of this comparison, the calculation unit 15 can signal the presence of the structural defect 10.3 near the aforementioned point. Stated otherwise, the calculation unit 15 is adapted for estimating or evaluating the position of the structural defect in the structure 10.

The scan frequency for each sensor is fixed so that the physical phenomenon to be observed is at the minimum greater than twice the physical frequency, so as to make it possible to readily utilize the sampling. The scan speed is adapted to suit the scan frequency.

FIG. 7 illustrates another comparison effected by the calculation unit 15, on the basis of the signals generated by another sensor 14: a detection threshold is applied to the number and/or to the value of the resonant frequencies f0 and f1 of the current transfer function (FIG. 7) with respect to the nominal transfer function (FIG. 5).

In practice, the algorithm and the detection thresholds are determined as a function of the type of structural defects to be monitored by priority.

In service, a monitoring method for detecting a structural defect 10.3 that may appear in the nacelle 1 in service comprises the steps of:
actuating several sensors 14 arranged so as to generate signals representative at least of an amplitude and/or of a frequency of vibrations produced in the structure 10 when the nacelle 1 is in service;
emitting, by means of each sensor 14, said signals by electromagnetic waves, for example by radiofrequency; and
evaluating, by means of at least one calculation unit 15, the differences existing between a current transfer function (FIG. 6; FIG. 7) resulting from said signals and a predetermined nominal transfer function (FIG. 5);
effecting, by means of the calculation unit 15, a comparison between each of said differences and a detection threshold HD; and
on the basis of said comparison, estimating or evaluating the size and/or the position of the structural defect 10.3 in the structure 10.

The monitoring method can furthermore comprise a step consisting in predetermining, at the level of each sensor 14, a nominal transfer function (FIG. 5) in the initial state of the structure 10 before the nacelle 1 is put into service.

According to another form of the present disclosure, taken in isolation or according to all technically possible combinations: Instead of a single calculation unit, the monitoring assembly comprises several calculation units, each calculation unit being incorporated into or associated with a respective sensor.

The monitoring assembly furthermore comprises transmission facilities each adapted for receiving said signals of a respective sensor and for transmitting them to a respective calculation unit, the transmission facilities being formed by radiofrequency-based identification components, for example according to the so-called RFID technology, which are already existing and onboard the aircraft. Such transmission facilities can be components distinct from the sensors, while in the example of the figures, a transmission facility is integrated into each respective sensor.

Each respective detection threshold is fixed in a relative rather than absolute manner. In this case, the calculation unit compares a current transfer function resulting from the signals of a sensor with at least one current transfer function resulting from the signals of at least one distinct sensor.

What is claimed is:

1. A monitoring assembly for detecting structural defects that may appear in an aircraft nacelle in service, the monitoring assembly comprising:
at least one composite material sandwich structure with at least two distinct strata, the composite material sandwich structure being adapted for forming at least one part of the aircraft nacelle; and
a plurality of sensors arranged so as to generate signals representative at least one of an amplitude and a frequency of vibrations produced in the composite material sandwich structure when the aircraft nacelle is in service, each sensor for emitting said signals by electromagnetic waves, wherein each sensor is formed by an electromechanical microsystem (MEMS) comprising means for converting mechanical energy into electrical energy; and
at least one calculation unit adapted:
for evaluating the differences existing between a current transfer function resulting from said signals and a predetermined nominal transfer function;
for effecting a comparison between each of said differences and a respective detection threshold (HD); and
on the basis of said comparison, for estimating or evaluating a size and/or a position of said structural defect in the composite material sandwich structure.

2. The monitoring assembly as claimed in claim 1, wherein a detection threshold (HD) is applied to a modulus of the current transfer function measured at a resonant frequency.

3. The monitoring assembly as claimed in claim 1, wherein a detection threshold is applied to at least one of a number and value(s) of a resonant frequency (frequencies) of the current transfer function with respect to the nominal transfer function.

4. The monitoring assembly as claimed in claim 1, wherein each respective detection threshold is fixed in an absolute manner.

5. The monitoring assembly as claimed in claim 4, wherein the respective detection threshold is fixed on the basis of the nominal transfer function.

6. The monitoring assembly as claimed in claim 1, wherein each respective detection threshold is fixed in a relative manner, the calculation unit comparing a current transfer function resulting from signals of a sensor with at least one current transfer function resulting from signals of at least one distinct sensor.

7. The monitoring assembly as claimed in claim 1, further comprising several calculation units, each calculation unit being incorporated into a respective sensor.

8. The monitoring assembly as claimed in claim 1, further comprising a calculation unit arranged remotely from the sensors and adapted for receiving said signals of each sensor.

9. The monitoring assembly as claimed in claim 1, furthermore comprising transmission facilities each adapted for receiving said signals of a respective sensor and for transmitting the signals to a respective calculation unit, the transmission facilities being formed by radiofrequency-based identification components onboard an aircraft.

10. The monitoring assembly as claimed in claim 1, wherein each sensor emits said signals with an intensity greater than an attenuation effected by the composite material sandwich structure.

11. The monitoring assembly as claimed in claim 1, wherein each sensor is of passive type and composed of silicon, each sensor comprising mechanical counting means.

12. The monitoring assembly as claimed in claim 1, wherein each sensor is integrated or embedded in the composite material sandwich structure.

13. The monitoring assembly as claimed in claim 1, wherein the sensors are distributed at several points of the composite material sandwich structure, so as to monitor the major part of the composite material sandwich structure.

14. The monitoring assembly as claimed in claim 1, wherein several sensors are arranged so as to measure vibrations produced between two distinct strata when the aircraft nacelle is in service.

15. A monitoring method for detecting structural defects that may appear in an aircraft nacelle in service, at least one part of the aircraft nacelle being formed by a composite material sandwich structure with at least two distinct strata, the monitoring method comprising steps of:
actuating several sensors arranged so as to generate signals representative at least one of an amplitude and a frequency of vibrations produced in the composite material sandwich structure when the aircraft nacelle is in service;
emitting, by means of each sensor, said signals by electromagnetic waves, each sensor being formed by an electromechanical microsystem (MEMS) comprising means for converting mechanical energy into electrical energy; and
evaluating, by means of at least one calculation unit, the differences existing between a current transfer function resulting from said signals and a predetermined nominal transfer function;
effecting, by means of the or of each calculation unit, a comparison between each of said differences and a respective detection threshold (HD); and
on the basis of said comparison, estimating or evaluating size and/or a position of said structural defect in the composite material sandwich structure.

16. The monitoring method as claimed in claim 15, furthermore comprising a step of predetermining, at the level of each sensor, a nominal transfer function in an initial state of the composite material sandwich structure before the aircraft nacelle is put into service.
